(19) United States
(12) Patent Application Publication
(10) Pub. No.: US 2020/0007440 A1
(43) Pub. Date: Jan. 2, 2020

(54) DYNAMIC RULE-BASED FLOW ROUTING IN NETWORKS

(71) Applicant: Microsoft Technology Licensing, LLC, Redmond, WA (US)

(72) Inventors: Zhenggen Xu, Sunnyvale, CA (US); Shafagh Zandi, San Francisco, CA (US)

(73) Assignee: Microsoft Technology Licensing, LLC, Redmond, WA (US)

(21) Appl. No.: 16/020,538

(22) Filed: Jun. 27, 2018

(51) Int. Cl. H04L 12/721; H04L 12/707; H04L 12/947; H04L 12/803

(52) U.S. Cl. CPC H04L 45/38; H04L 45/24; H04L 47/125; H04L 45/22; H04L 49/25

(57) ABSTRACT

The disclosed embodiments provide a system for performing flow routing in a network. The system may include one or more nodes in the network. Each of the nodes may obtain a dynamic rule that includes a flow definition and a routing action specifying an ECMP group in the network. When a flow in the network matches the flow definition, the node routes traffic in the flow to the ECMP group based on the routing action. The node then performs subsequent routing of the network traffic in the flow to reflect changes in membership in the ECMP group.

### BACKGROUND

### Field

The disclosed embodiments relate to flow routing in networks. More specifically, the disclosed embodiments relate to techniques for performing dynamic rule-based flow routing in networks.

### Related Art

Switch fabrics are commonly used to route traffic within data centers. For example, network traffic may be transmitted to, from, or between servers in a data center using a layer of “leaf” switches connected to a fabric of “spine” switches. Traffic from a first server to a second server may be received at a first leaf switch to which the first server is connected, routed or switched through the fabric to a second leaf switch, and forwarded from the second leaf switch to the second server.

To balance load across a switch fabric, an equal-cost multi-path (ECMP) routing strategy may be used to distribute flows across different paths in the switch fabric. On the other hand, such routing may complicate visibility into the flows across the switch fabric, prevent selection of specific paths for specific flows, and result in suboptimal network link utilization when bandwidth utilization across flows is unevenly distributed. Moreover, conventional techniques for overriding ECMP flow routing may insert static rules in forwarding tables of the switch fabric, which may cause traffic to be dropped or routed to a black hole whenever a network topology and/or routing change occurs.

### BRIEF DESCRIPTION OF THE FIGURES

FIG. 1 shows a switch fabric in accordance with the disclosed embodiments.

FIG. 2 shows the use of a rule to perform flow routing in a network in accordance with the disclosed embodiments.

FIG. 3 shows a flowchart illustrating a process of performing flow routing in a network in accordance with the disclosed embodiments.

FIG. 4 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor (including a dedicated or shared processor core) that executes a particular software module or a piece of code at a particular time, and/or other programmable-logic devices now known or later developed. When the hardware modules or apparatus are activated, they perform the methods and processes included within them.

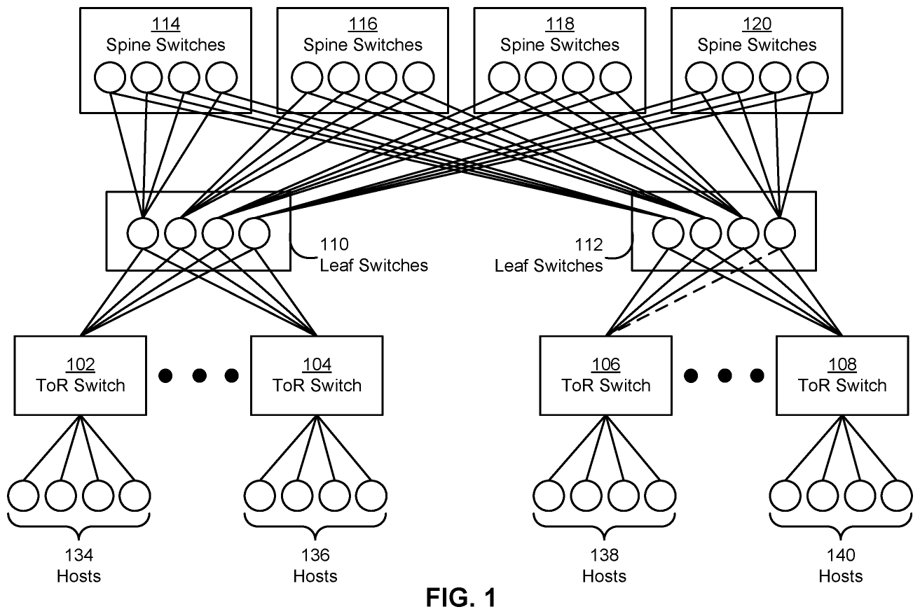

The disclosed embodiments provide a method, apparatus, and system for performing dynamic rule-based routing in networks. As shown in FIG. 1, a network may include a switch fabric that includes a number of top of rack (ToR) switches 102-108 that are connected to multiple sets of leaf switches 110-112 via a set of physical and/or logical links. In turn, leaf switches 110-112 are connected to multiple sets of spine switches 114-120 in the switch fabric via another set of physical and/or logical links.

The switch fabric may be used to route traffic to, from, or between nodes connected to the switch fabric, such as a set of hosts 134-140 connected to ToR switches 102-108. For example, the switch fabric may include an InfiniBand (InfiniBand™ is a registered trademark of InfiniBand Trade Association Corp.), Ethernet, Peripheral Component Interconnect Express (PCIe), and/or other interconnection mechanism among compute and/or storage nodes in a data center. Within the data center, the switch fabric may route north-south network flows between external client devices and servers connected to ToR switches 102-108 and/or east-west network flows between the servers.

Switches in the switch fabric may be connected in a leaf-spine topology, fat tree topology, and/or Clos topology. First, each ToR switch 102-108 provides connection points to the switch fabric for a set of hosts 134-140 (e.g., servers, storage arrays, etc.). For example, each ToR switch 102-108 may connect to a set of servers in the same physical rack as the ToR switch, and each server may connect to a single ToR switch in the same physical rack.

Next, ToR switches 102-104 are connected to one set of leaf switches 110, and ToR switches 106-108 are connected to a different set of leaf switches 112. ToR switches 102-104 and leaf switches 110 may form one point of delivery (pod) in the switch fabric, and ToR switches 106-108 and leaf switches 112 may form a different pod in the switch fabric. ToR switches in each pod are fully connected to the leaf switches in the same pod, so that each ToR switch is connected to every leaf switch in the pod and every leaf switch is connected to every ToR switch in the pod.

Pods containing different sets of leaf switches 110-112 and ToR switches 102-108 are then connected by multiple sets of spine switches 114-120. Each set of spine switches 114-120 may represent an independent fabric “plane” that routes traffic between pods in the switch fabric. In addition, each plane of spine switches 114-120 may be connected to a different leaf switch from each pod. For example, spine switches 114 may connect a first switch in leaf switches 110 to a first switch in leaf switches 112, spine switches 116 may connect a second switch in leaf switches 110 to a second switch in leaf switches 112, spine switches 118 may connect a third switch in leaf switches 110 to a third switch in leaf switches 112, and spine switches 120 may connect a fourth switch in leaf switches 110 to a fourth switch in leaf switches 112.

As a result, connections between independent pods of ToR switches 102-108 and leaf switches 110-112 and independent planes of spine switches 114-120 may allow network flows to be transmitted across multiple paths within the switch fabric. At the same time, the switch fabric may be scaled by adding individual pods and/or planes may be added to the fabric without changing existing connections in the switch fabric.

During routing of traffic through the switch fabric, the switches may use an equal-cost multi-path (ECMP) strategy and/or other multipath routing strategy to distribute flows across different paths in the switch fabric. For example, the switches may distribute load across the switch fabric by selecting paths for network flows using a hash of flow-related data in packet headers (e.g., source Internet Protocol (IP) address, destination IP address, protocol, source port, destination port, etc.). However, conventional techniques for performing load balancing in switch fabrics may result in less visibility into flows across the network links, an inability to select specific paths for specific flows, and uneven network link utilization when bandwidth utilization is unevenly distributed across flows.

In one or more embodiments, the switch fabric of FIG. 1 includes functionality to improve routing of network traffic by using dynamic rules to route flows in the switch fabric. For example, the rules may be used to dynamically override default routing behavior and/or customize the routing of flows in the switch fabric. As a result, the rules may be applied by ToR switches 102-108 and leaf switches 110-112, which have multiple paths to destinations in the switch fabric. On the other hand, spine switches 114 in the switch fabric may optionally lack rules for routing flows when each spine switch only has a single path (through a single leaf switch and a single ToR switch) to a given destination.

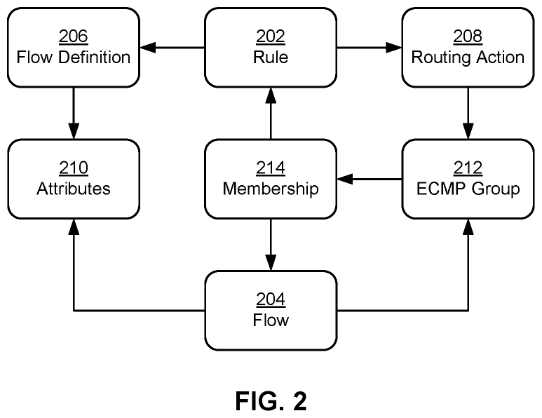

As shown in FIG. 2, a rule 202 for performing dynamic flow routing in a network (e.g., the switch fabric of FIG. 1) includes a flow definition 206 and a routing action 208. Rule 202 may be defined for a given node in the network, such as ToR, leaf, and/or spine switch in the switch fabric. Rule 202 may then be used with other rules defined for other nodes in the network to customize the routing of flows in the network.

Flow definition 206 may specify one or more attributes 210 of a flow 204 in the network. For example, flow definition 206 may include a destination IP address, source IP address, subnet, Transmission Control Protocol (TCP) port, User Datagram Protocol (UDP) port, and/or HyperText Transfer Protocol (HTTP) header in network traffic transmitted within the switch fabric.

Flow definition 206 may also, or instead, specify an application signature that uniquely identifies an application that uses the network. For example, the application signature may include a source and/or destination TCP port, one or more protocols used by the application, an HTTP header associated with the application, and/or other attributes associated with network traffic sent or received by the application.

Routing action 208 may include information and/or directions for overriding the default routing behavior in the network. For example, a node in the network (e.g., a switch in the switch fabric) may apply routing action 208 to network traffic received at the node when the network traffic has attributes 210 that match flow definition 206. To ensure that rule 202 is applied in a way that reflects changes to the state and/or topology of the network, routing action 208 may specify an ECMP group 212 to which network traffic in flow 204 is to be redirected. In turn, ECMP group 212 may include some or all links connected to the node.

In one or more embodiments, attributes 210 in flow definition 206 and ECMP group 212 in routing action 208 are selected to redirect traffic in flow 204 to reserve a certain amount of bandwidth for network traffic from certain applications. For example, a number of rules may be defined by a network administrator and inserted into one or more switches in the switch fabric to prioritize the transmission of certain types of network traffic and/or network traffic from certain applications. A first rule may include a flow definition that identifies the high-priority traffic, as well as an ECMP group containing a link, path, and/or fabric plane that is reserved for use by the high-priority traffic. A second rule may be defined with a flow definition that contains subnets associated with other, lower priority traffic and a different ECMP group that contains non-reserved links, paths, and/or fabric planes in the network. Consequently, the high-priority traffic may be matched to the flow definition in the first rule and redirected to the reserved ECMP group, while the lower priority traffic may be matched to the flow definition in the second rule and load balanced across the non-reserved links, paths, and/or fabric planes.

Rule 202 may also, or instead, be used to redistribute flows in the network when an imbalance in link usage is detected. For example, a centralized controller and/or other component may analyze telemetry data collected from switches and/or other nodes in the network. When the telemetry data indicates an imbalance in load across a set of links in an equal-cost multi-path (ECMP) group that is used to implement default routing behavior in the network, the component may dynamically generate rule 202 to redistribute some of the load to underutilized links in the ECMP group. Flow definition 206 in rule 202 may thus include attributes 210 of a portion of network traffic transmitted in the ECMP group, and routing action 208 may include a different ECMP group 212 that contains one or more of the underutilized links. The component may also monitor subsequent link usage in the ECMP group after rule 202 is implemented and modify rule 202 and/or create other rules for redistributing load in the links based on the subsequent link usage. In other words, the component may operate in a feedback loop that continuously tracks the distribution of load across links in the network and creates rules for rebalancing the load among the links accordingly.

Rule 202 may additionally be applied to flow 204 in a way that reflects changes in membership 214 within ECMP group 212. Such changes in membership 214 may occur when links are added to the network or a node and/or removed from the network or a node. When a link in ECMP group 212 is no longer available for use in routing network traffic in flow 204 (e.g., because the link is down or removed and/or a destination associated with flow 204 is no longer reachable via the link), the link may be removed from ECMP group 212. When all links in ECMP group 212 have been removed, the network traffic may be routed according to a default routing action, such as a routing table entry in the node. The node may also, or instead, drop the network traffic when ECMP group 212 is empty. In general, the node may perform a configurable action when network traffic in flow 204 cannot be routed to one or more destinations based on ECMP group 212 and/or other information in routing action 208.

Rule 202 may be implemented and/or applied using hardware and/or software on a given node of the network. For example, each node may include one or more processes in a control plane of the node. Each process may execute on a central-processing unit (CPU) and inject rules to override the default routing behavior of hardware on the node.

In another example, the nodes may include programmable ASICs that track ECMP groups, routes, and/or reachabilities in the network; identify flows that match flow definitions in the rules; and apply routing actions in the rules to the identified flows. To apply a routing action in a rule to a corresponding flow, a programmable ASIC may identify a first set of links in the ECMP group specified in the routing action and a second set of links in potential routes associated with the flow. The ASIC may generate another ECMP group as the intersection of the first and second sets of links and route network traffic in the flow to the generated ECMP group. If the generated ECMP group is empty, the ASIC may route the network traffic along one of the potential routes, drop the network traffic, and/or otherwise modify routing of the network traffic to reflect the lack of links in the generated ECMP group.

By defining rules that identify flows in the network and perform routing actions based on the flows, the disclosed embodiments may allow routing of traffic in the network to be customized and/or configured based on attributes associated with the flows. Moreover, such routing may be dynamically applied and/or modified in a way that is resilient to topology changes and/or faults in the network. The routing may additionally be performed without requiring changes to hardware and/or control protocols in nodes of the network. Consequently, the disclosed embodiments may improve the performance, usage, routing behavior, and/or fault tolerance of the network.

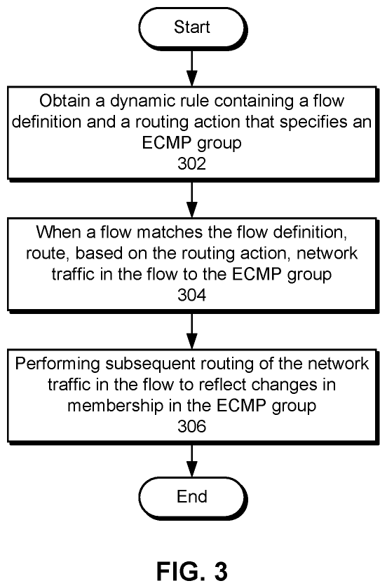

FIG. 3 shows a flowchart illustrating a process of performing flow routing in a network in accordance with the disclosed embodiments. In one or more embodiments, one or more of the steps may be omitted, repeated, and/or performed in a different order. Accordingly, the specific arrangement of steps shown in FIG. 3 should not be construed as limiting the scope of the embodiments.

Initially, a dynamic rule containing a flow definition and a routing action that specifies an ECMP group is obtained (operation 302). For example, the dynamic rule may be received by a node in the network from an administrator and/or generated by a centralized controller in the network. The flow definition may include a destination IP address, source IP address, subnet, Transmission Control Protocol (TCP) port, User Datagram Protocol (UDP) port, and/or HyperText Transfer Protocol (HTTP) header associated with a flow in the network.

The dynamic rule may be created to reserve network bandwidth for an application. As a result, the flow definition may include an application signature for the application (e.g., TCP ports, UDP ports, HTTP headers, and/or other identifying attributes of the application), and the ECMP group may include a dedicated link or plane for transmitting network traffic between the application and a destination in the network.

The dynamic rule may also, or instead, be automatically generated to redistribute flows in the network across a set of links when an imbalance in link usage is detected. For example, the centralized controller may analyze telemetry data collected from the nodes to detect an imbalance in load across a set of links in an ECMP group of the fabric. As a result, the centralized controller may generate one or more rules that assign one or more flows to underutilized links in the ECMP group (e.g., by creating new ECMP groups containing the underutilized links and specifying the new ECMP groups in routing actions of the rules).

When a flow matches the flow definition, network traffic in the flow is routed to the ECMP group based on the routing action (operation 304). For example, a node in the network (e.g., a switch in ToR tier, leaf tier, and/or spine tier of the network) may match one or more attributes of the network traffic to corresponding attributes of the flow definition to determine that the dynamic rule is applicable to the network traffic. The node may then obtain the routing action from the dynamic rule and redirect the network traffic to links in the ECMP group from the routing action that are on paths to the destination associated with the flow.

Subsequent routing of the network traffic in the flow is also performed to reflect changes in membership in the ECMP group (operation 306). For example, routing of the network traffic to a link may be discontinued after the link is removed from the ECMP group (e.g., because the link is down, removed, or no longer on a path to the destination associated with the flow). In another example, the network traffic may be routed according to a default routing action (e.g., a routing table in a node) dropped when the ECMP group is empty (e.g., after all links have been removed from the ECMP group). In a third example, the network traffic may be dropped in response to an empty ECMP group for the flow. In a fourth example, the network traffic may be routed to a new set of links in the ECMP group after the ECMP group is redefined to include the new set of links (e.g., in response to changes in link usage and/or network traffic priorities).

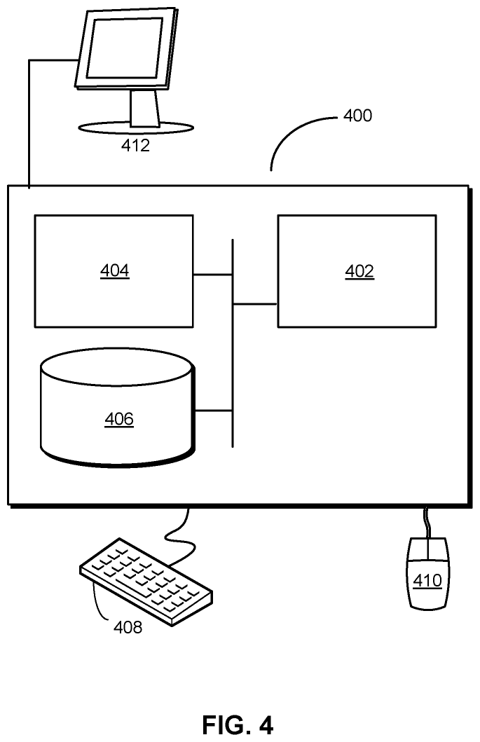

FIG. 4 shows a computer system 400 in accordance with the disclosed embodiments. Computer system 400 includes a processor 402, memory 404, storage 406, and/or other components found in electronic computing devices. Processor 402 may support parallel processing and/or multi-threaded operation with other processors in computer system 400. Computer system 400 may also include input/output (I/O) devices such as a keyboard 408, a mouse 410, and a display 412.

Computer system 400 may include functionality to execute various components of the present embodiments. In particular, computer system 400 may include an operating system (not shown) that coordinates the use of hardware and software resources on computer system 400, as well as one or more applications that perform specialized tasks for the user. To perform tasks for the user, applications may obtain the use of hardware resources on computer system 400 from the operating system, as well as interact with the user through a hardware and/or software framework provided by the operating system.

In one or more embodiments, computer system 400 provides a system for performing flow routing in a network. The system may include one or more nodes in the network. Each of the nodes may obtain a dynamic rule that includes a flow definition and a routing action specifying an ECMP group in the network. When a flow in the network matches the flow definition, the node routes traffic in the flow to the ECMP group based on the routing action. The node then performs subsequent routing of the network traffic in the flow to reflect changes in membership in the ECMP group.

In addition, one or more components of computer system 300 may be remotely located and connected to the other components over a network. Portions of the present embodiments may also be located on different nodes of a distributed system that implements the embodiments. For example, the present embodiments may be implemented using a cloud computing system that performs dynamic rule-based flow routing in a remote network.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

1. A method, comprising:
upon detecting an imbalance in link usage within a network, based on telemetry data collected from multiple nodes in the network, automatically generating a dynamic rule to redistribute flows in the network across a set of links, wherein the dynamic rule comprises:
a flow definition; and
a routing action specifying an equal-cost multi-path (ECMP) group;
when a flow in the network matches the flow definition, routing, by a node in the network based on the routing action, network traffic in the flow to the ECMP group; and
performing subsequent routing of the network traffic in the flow to reflect changes in membership in the ECMP group.

2. The method of claim 1, wherein performing subsequent routing of the network traffic in the flow to reflect changes in membership in the ECMP group comprises:
discontinuing routing of the network traffic in the flow to a link after the link is removed from the ECMP group.

3. The method of claim 1, wherein performing subsequent routing of the network traffic in the flow to reflect changes in membership in the ECMP group comprises:
routing the network traffic in the flow according to a default routing action when the ECMP group is empty.

4. The method of claim 1, wherein performing subsequent routing of the network traffic in the flow to reflect changes in membership in the ECMP group comprises:
dropping the network traffic in the flow when the ECMP group is empty.

5. (canceled)

6. The method of claim 1, wherein the network comprises:
a top of rack (ToR) tier that connects a set of hosts to the network;
a leaf tier that connects the ToR tier and a spine tier; and
the spine tier comprising a set of independent fabric planes.

7. The method of claim 6, wherein the node is in the ToR tier or the leaf tier.

8. The method of claim 1, wherein:
the flow definition comprises an application signature for an application; and
the ECMP group comprises a dedicated link for transmitting the network traffic between the application and a destination.

9. The method of claim 1, wherein the flow definition comprises a destination Internet Protocol (IP) address.

10. The method of claim 1, wherein the flow definition comprises at least one of:
a source IP address;
a subnet;
a Transmission Control Protocol (TCP) port;
a User Datagram Protocol (UDP) port;
a HyperText Transfer Protocol (HTTP) header; and
an application signature.

11. A system, comprising:
one or more processors; and
memory storing instructions that, when executed by the one or more processors, cause the system to:
upon detecting an imbalance in link usage within a network, based on telemetry data collected from nodes in the network, automatically generate a dynamic rule to redistribute flows in the network across a set of links, wherein the dynamic rule comprises:
a flow definition; and
a routing action specifying an equal-cost multi-path (ECMP) group in the network;
when a flow in the network matches the flow definition, route, based on the routing action, traffic in the flow to the ECMP group; and
perform subsequent routing of the network traffic in the flow to reflect changes in membership in the ECMP group.

12. The system of claim 11, wherein performing subsequent routing of the network traffic in the flow to reflect changes in membership in the ECMP group comprises:
discontinuing routing of the network traffic in the flow to a link after the link is removed from the ECMP group.

13. The system of claim 11, wherein performing subsequent routing of the network traffic in the flow to reflect changes in membership in the ECMP group comprises:
routing the network traffic in the flow according to a default routing action when the ECMP group is empty.

14. The system of claim 11, wherein performing subsequent routing of the network traffic in the flow to reflect changes in membership in the ECMP group comprises:
dropping the network traffic in the flow when the ECMP group is empty.

15. (canceled)

16. (canceled)

17. The system of claim 11, wherein the network comprises:
a top of rack (ToR) tier that connects a set of hosts to the network;
a leaf tier that connects the ToR tier and a spine tier; and
the spine tier comprising a set of independent fabric planes.

18. The system of claim 11, wherein:
the flow definition comprises an application signature for an application; and
the ECMP group comprises a dedicated link for transmitting the network traffic between the application and a destination.

19. The system of claim 11, wherein the flow definition comprises at least one of:
a destination Internet Protocol (IP) address;
a source IP address;
a subnet;
a Transmission Control Protocol (TCP) port;
a User Datagram Protocol (UDP) port;
a HyperText Transfer Protocol (HTTP) header; and
an application signature.

20. A non-transitory computer-readable storage medium storing instructions that when executed by a computer cause the computer to perform a method, the method comprising:
upon detecting an imbalance in link usage within a network, based on telemetry data collected from nodes in the network, automatically generating a dynamic rule to redistribute flows in the network across a set of links, wherein the dynamic rule comprises:
a flow definition; and
a routing action specifying an equal-cost multi-path (ECMP) group;
when a flow in the network matches the flow definition, routing, based on the routing action, network traffic in the flow to the ECMP group; and
performing subsequent routing of the network traffic in the flow to reflect changes in membership in the ECMP group.

21. The non-transitory computer-readable storage medium of claim 20, wherein performing subsequent routing of the network traffic in the flow to reflect changes in membership in the ECMP group comprises:
discontinuing routing of the network traffic in the flow to a link after the link is removed from the ECMP group.

22. The non-transitory computer-readable storage medium of claim 20, wherein performing subsequent routing of the network traffic in the flow to reflect changes in membership in the ECMP group comprises:
routing the network traffic in the flow according to a default routing action when the ECMP group is empty.

23. The non-transitory computer-readable storage medium of claim 20, wherein performing subsequent routing of the network traffic in the flow to reflect changes in membership in the ECMP group comprises:
dropping the network traffic in the flow when the ECMP group is empty.
